(19) United States
(12) Patent Application Publication
(10) Pub. No.: US 2010/0220563 A1
(43) Pub. Date: Sep. 2, 2010

(54) RECORDING CONTROL DEVICE, LASER DRIVE DEVICE, INFORMATION RECORDING DEVICE, SIGNAL TRANSMISSION METHOD, AND RECORDING/REPRODUCTION CONTROL DEVICE

(76) Inventors: Toyoji Gushima, Osaka (JP); Makoto Usui, Osaka (JP)

Correspondence Address: WENDEROTH, LIND & PONACK L.L.P., 1030 15th Street, N.W., Suite 400 East, Washington, DC, 20005-1503, US

(21) Appl. No.: 11/997,494

(22) PCT Filed: May 30, 2006
(86) PCT No.: PCT/JP2006/310712

§ 371 Date: Jan. 31, 2008

(30) Foreign Application Priority Data
Aug. 2, 2005 (JP) 2005-223643

(51) Int. Cl. G11B 19/02

(52) U.S. Cl. 369/47.2; G9B/19.001

(57) ABSTRACT

An information recording device that offers high performance with an inexpensive structure is achieved without requiring a dedicated line for transmitting and receiving control data. The information recording device (1105) is a device for outputting a recording control signal to a laser drive device (1106) for driving a laser light source device to record information to an optical disk, comprising a recording data generation component (1206), a control data generation component (1207), an output component (1205), and a control component (1301). The recording data generation component (1206) generates recording data including information to be recorded to the optical disk, the control data generation component (1207) generates control data that controls the laser drive device (1106). The output component (1205) outputs the recording control signal in which the recording data and the control data are multiplexed. The control component (1301) controls at least one of the recording data generation component (1206), the control data generation component (1207) and the output component (1205).

### TECHNICAL FIELD

The present invention relates to an information recording device that records or reproduces information by using a semiconductor laser or other such laser light source device to irradiate an information recording medium with a laser beam, and more particularly relates to a laser drive device for driving a laser light source device, to a recording control device for generating a recording control signal including information to be recorded and outputting this signal to a laser drive device, to a method for transmitting signals from a recording control device to a laser drive device, and to a recording and reproduction control device for also reproducing information.

### BACKGROUND ART

With the development of an information society, the transmission of information continues to be performed at ever higher speeds and large quantities, and the information recording media used to record and store such information also need to provide higher speeds and capacities.

In the midst of this, optical disks have become extremely popular interchangeable recording media because they allow information to be recorded and reproduced at high speed and have a large capacity. Types of recordable optical disk include a phase change type that allows rewriting, and an organic dye type that allows recording only once. With an optical disk such as this, a spiral track or concentric circular track is provided to the disk surface, this track is irradiated with a spot obtained by focusing a light beam, and the irradiation power level of the light beam is varied according to the recording data, which imparts a thermal change to the recording film and allows information to be recorded.

A common method for recording information to an optical disk is a light modulation recording method in which a spiral track or concentric circular track is provided to the disk surface, this track is irradiated with a spot obtained by focusing a laser beam or other such light beam, and the intensity of the irradiating light beam is modulated according to the data to be recorded. This recording method can be applied to a wide range of optical disks, typical examples of which include phase change optical disks, organic dye optical disks, and opto-magnetic disks.

Also, a known method for recording data at a high density to an optical disk is to subject user data including the information to be recorded to encoding in which redundant data such as an error correction code is added, modulate with a run-length limiting code, and record modulated data that has been converted to NRZI format. This method involves modulating so that the front and rear edges of recording marks correspond to “1” in a digital signal, and is suited to increasing density because it allows more bits to be allocated to recording marks of a given length than with a pulse position modulation method in which modulation is performed so that the positions of recording marks correspond to a “1” in a digital signal.

Also, since the width of a recording mark represents information with this method, the recording marks must be formed free of distortion, that is, the marks must be uniform at the front and rear ends. Because of the heat accumulation effect in recording films such as a phase change optical disk, particularly when a long mark is recorded, the width of the recording mark in its radial direction becomes larger towards the rear half, resulting in so-called teardrop distortion. To solve this problem, a recording method has been proposed in which a single recording mark is formed by irradiation with train of short pulses (see Patent Document 1, for example).

Another method that has been proposed is to compensate for peak shift due to frequency characteristics during reproduction or to thermal interference between marks by recording such that the pulse positions corresponding to recording mark head portions and recording mark tail portions of a recording pulse train are varied for each mark length and space length of the data to be recorded (see Patent Document 2, for example).

The above processing, in which recording is performed while suitably controlling the recording pulses that determine the power waveform of laser emission in order to form recording marks of good quality on an optical disk, is called a write strategy. This requires precise control of the laser power level and the time axis of the recording pulses in order to record at high density.

With an ordinary optical disk drive for recording information to an optical disk, a semiconductor laser or other such laser light source device is installed in an optical head, which is a movable component, and the main recording signal processing circuit for error correction coding, modulation coding, or the like is usually mounted on a main printed board, which is a stationary component. Also, a laser drive circuit for driving the semiconductor laser is mounted in the nearby optical head, and the optical head is connected by a flexible printed cable to the main printed board. Recording data is sent from the recording signal processing circuit, and the laser drive circuit sends signals to perform serial communications for sending settings so that the semiconductor laser will emit at the proper power level (see Patent Documents 3 and 4, for example).

Patent Document 1: Japanese Laid-Open Patent Application H3-185628

Patent Document 2: Japanese Laid-Open Patent Application H7-129959

Patent Document 3: Japanese Laid-Open Patent Application H11-283249

Patent Document 4: Japanese Laid-Open Patent Application 2004-274462

### DISCLOSURE OF INVENTION

With the constitution in Patent Document 1, however, a dedicated serial interface line for exchanging laser drive current and other such control data, in addition to recording data, is necessary as wiring between a controller LSI chip that incorporates a recording control circuit, and a driver IC that incorporates a laser drive circuit.

Consequently, there are more terminals for the controller LSI chip and the driver IC, making it more difficult to design the flexible printed cable that connects these, and also drives up the manufacturing cost.

Serial interface signal transmission is generally carried out at a TTL level (0 to 5V), so considerable radiation noise is inevitably generated during passage through the flexible printed cable.

Also, every time control data is transferred through a dedicated serial interface line, noise creeps in through the board, and this degrades reproduction signal quality.

Also, as recording density rises, the write strategy becomes more complicated and diverse, and the amount of control data being transferred increases. Moreover, because recording needs to be performed faster, settings for the laser drive circuit must be accomplished in a shorter time, and a clock frequency of serial interface is reached to several dozen megahertz in order to transfer more control data in a shorter time.

The present invention was conceived in light of these problems, and it is an object thereof to provide an inexpensive and high-performance information recording device that does not require a dedicated line to send and receive control data.

To solve the above problems, the recording control device of the present invention is a recording control device for outputting a recording control signal to a laser drive device for driving a laser light source device to record information to an optical disk, comprising a recording data generation component operable to generate recording data including information to be recorded to the optical disk, a control data generation component operable to generate control data that controls the laser drive device, an output component operable to output the recording control signal in which the recording data and the control data are multiplexed, and a control component operable to control at least one of the recording data generation component, the control data generation component, and the output component.

Also, the control component generates a mode switching signal for selecting either to output the recording data or to output the control data, and the output component selectively outputs the recording data and the control data according to the mode switching signal.

Also, the output component further outputs a selection signal for making it possible to distinguish whether the recording data is being outputted or the control data is being outputted. The selection signal outputted here may be transmitted separately from the recording control signal, or may be superimposed on the recording control signal.

Also, the control component controls operation such that the output component selects the control data in a period at least excluding a recording operation period in which information is recorded to the optical disk. The recording operation period referred to here is the period in which the laser light source device is driven to record to the optical disk, and is the period in which the recording operation is actually carried out.

Also, the control component may control operation such that the output component selects the control data at least during a recording operation period in which information is recorded to the optical disk and a period in which recording marks are not formed.

Also, the constitution may be such that the control component generates a recording gate signal at least indicating a recording operation period in which information is recorded to the optical disk, the recording data generation component generates recording data on the basis of the recording gate signal, and the output component outputs the recording data during the recording operation period on the basis of the recording gate signal, and outputs the control signal so that the control data will be outputted except during the recording operation period.

Also, the constitution may be such that the control component controls the control data generation component and the output component so that the control data will be split up and transferred.

Also, the constitution may be such that the control component generates an identification header for making it possible to distinguish between the recording data and the control data from the multiplexed recording control signal, and the output component outputs the recording control signal containing the identification header.

Also, the constitution may be such that the recording data generation component generates the recording data so as to include modulated data that has been modulated according to a specific rule, and a clock signal synchronized to the modulated data.

Also, the constitution may be such that the recording data generation component generates the recording data so as to include a pulse signal that controls a power waveform of laser emission in the recording of information to the optical disk.

Also, the constitution may be such that the control data generation component generates the control data so as to include setting data held in the laser drive device, a trigger signal indicating the timing at which the laser drive device is to hold the setting data, and an enable signal indicating the transmission period of the setting data.

Also, the constitution may be such that the control data generation component generates the control data so as to include a power setting code for controlling the laser emission power level in the recording of information to the optical disk.

Also, the constitution may be such that the control data generation component generates the control data so as to include a current value setting code for controlling a drive current value for the laser light source device in the recording of information to the optical disk.

Also, the constitution may be such that the control data generation component generates the control data so as to include a drive current amount control signal for controlling the increase and decrease of the amount of drive current for the laser light source device in the recording of information to the optical disk.

Also, it is preferable if the output component comprises a differential signal driver circuit for subjecting the recording control signal to low amplitude differential output.

To solve the above problems, the laser drive device of the present invention is a laser drive device for driving a laser light source device to record information to an optical disk, comprising an input component operable to receive a recording control signal in which recording data including information to be recorded to the optical disk and control data for controlling the laser drive device are multiplexed, and fetch the control data and the recording data from the recording control signal respectively, a control data holding component operable to hold the control data, and an output component operable to output a drive signal for driving the laser light source device on the basis of the recording data and the control data.

Also, the input component may further receive a selection signal for making it possible to distinguish between the recording data and the control data, and fetch the control data from the recording control signal on the basis of the selection signal. The selection signal received here may be transmitted separately from the recording control signal, or may be superimposed on the recording control signal.

Also, the constitution may be such that the recording control signal includes an identification header for making it possible to distinguish between the recording data and the control data, and the input component fetches the control data from the recording control signal by detecting the identification header.

Also, the constitution may be such that the control data includes at least setting data to be held in the control data holding component, a trigger signal indicating the timing for holding the setting data, and an enable signal indicating the transmission period of the setting data, and the control data holding component holds the setting data on the basis of the trigger signal and the enable signal.

Also, the constitution may be such that the control data includes at least a power setting code for controlling the laser emission power level in the recording of information to the optical disk, the control data holding component holds the power setting code included in the control data, and the output component varies the drive signal level of the laser light source device on the basis of the power setting code.

Also, the constitution may be such that the control data includes at least a current value setting code for controlling a drive current value for the laser light source device in the recording of information to the optical disk, the control data holding component holds the current value setting code included in the control data, and the output component varies the drive current value of the laser light source device on the basis of the held current value setting code.

Also, the constitution may be such that the control data includes at least a drive current amount control signal for controlling the increase and decrease of the amount of drive current for the laser light source device in the recording of information to the optical disk, and the output component increases or decreases the drive current amount of the laser light source device on the basis of the drive current amount control signal included in the control data.

Also, the constitution is preferably such that the recording control signal is transmitted as a low amplitude differential signal, and the input component comprises a differential signal receiver circuit for receiving the low amplitude differential signal.

To solve the above problems, the information recording device of the present invention is an information recording device for recording information to an optical disk, comprising a recording control device, a laser drive device, and a light source device. The recording control device has a recording data generation component operable to generate recording data including information to be recorded to the optical disk, a control data generation component operable to generate control data that controls a laser drive device, an output component operable to output a recording control signal in which the recording data and the control data are multiplexed, and a control component operable to control at least one of the recording data generation component, the control data generation component, and the output component. The laser drive device has an input component operable to receive the recording control signal outputted from the recording control device, and fetch the control data and the recording data from the recording control signal respectively, a control data holding component operable to hold the control data, and an output component operable to output a drive signal on the basis of the recording data and the control data. The laser light source device is configured to be driven by the drive signal, and irradiates the optical disk with a laser beam.

To solve the above problems, the signal transmission method of the present invention is a method for signal transmission between a recording control device which generates and transmits recording data including information to be recorded to an optical disk and control data for controlling a level of a laser beam directed at the optical disk, and a laser drive device for driving a laser light source device for irradiating the optical disk with the laser beam, in an information recording device for recording information by irradiating the optical disk with the laser beam, wherein a recording control signal in which the recording data and the control data are multiplexed is transmitted from the recording control device to the laser drive device.

To solve the above problems, another signal transmission method of the present invention is a method for signal transmission between a laser drive device for driving a laser light source device that irradiates an optical disk with a laser beam, a detection device for detecting as an electrical signal the reflected light of the laser beam directed at the optical disk, and a recording and reproduction control device that generates recording data including information to be recorded to the optical disk and control data for controlling a level of the laser beam directed at the optical disk, sends the recording data and control data to the laser drive device, receives electrical signal from the detection device, and reproduces information, in an information recording device for recording and reproducing information by irradiating the optical disk with the laser beam, wherein a recording control signal in which the recording data and the control data are multiplexed is transmitted as a low amplitude differential signal from the recording control device to the laser drive device.

To solve the above problems, the recording and reproduction control device of the present invention is a recording and reproduction control device for outputting a recording control signal to a laser drive device for driving a laser light source device to record information to an optical disk, and receiving an electrical signal from a detection device for detecting as the electrical signal a reflected light of the laser beam directed at the optical disk to reproduce information, comprising a recording data generation component, a control data generation component, an output component, a control component, and a reproduction signal processing component. The recording data generation component generates recording data including information to be recorded to the optical disk. The control data generation component generates control data that controls the laser drive device. The output component outputs to the laser drive device a recording control signal in which the recording data and the control data are multiplexed. The control component controls at least one of the recording data generation component, the control data generation component, and the output component. The reproduction signal processing component receives the electrical signal from the detection device and reproducing information.

Also, the output component of the recording and reproduction control device may transmit the recording control signal as a low amplitude differential signal.

Using the recording control device of the present invention, the laser drive device of the present invention, the signal transmission method of the present invention, the recording and reproduction control device of the present invention, and the information recording device of the present invention, in which these are combined, makes it possible for the recording data and control data necessary to record information to an optical disk to be transmitted more efficiently, with fewer signal lines.

Therefore, it is possible to reduce the number of connecting signal lines between a controller LSI chip that includes a recording control device normally mounted on a main board, and a laser driver IC normally incorporated into an optical head, and this makes it easier to design a flexible printed cable that connects these circuits, and also reduces the number of external terminals of each LSI, which helps lower the manufacturing cost.

Also, because the dedicated serial interface line used in the past to transfer control data is eliminated, and with the structure of the present invention in which this is multiplexed with the recording data transmission line and theses are collectively sent by low amplitude differential transmission, a situation is avoided in which noise creeps in through the board and diminishes reproduction performance every time control data is transferred. The effect of noise is particularly great in reproduction because it involves not only reproducing recorded data, but also reproducing address information and so forth that has been modulated in prepits or a wobble track, and the reproduction of such address information and so forth is performed regardless of whether or not a recording operation is underway. The present invention, the constitution of which reduces noise regardless of whether or not a recording operation is underway, is also very effective from this standpoint.

Also, using low amplitude differential transmission increases the control data transfer rate, and even when recording density rises and the write strategy becomes more complicated and diverse, and the amount of control data being transferred increases, it will still be possible to control the settings of a laser drive device in a short time, and high recording speed doubling can be achieved more easily.

Therefore, it is also possible to eliminate external parts for noise reduction or EMI (Electro Magnetic Interference) suppression, and it is possible to provide an inexpensive, high-performance optical disk recording device.

### BRIEF DESCRIPTION OF DRAWINGS

FIG. 1 is a block diagram of the structure of the optical disk recording device pertaining to the present invention;

FIG. 2 is a block diagram of an example of the structure of the recording and reproduction control circuit and laser drive circuit pertaining to the present invention;

FIG. 3 is a simplified block diagram of an example of the internal structure of the recording and reproduction control circuit in an embodiment;

FIG. 4 is a diagram of the timing of the recording and reproduction of information in an embodiment;

FIG. 5 is a schematic diagram illustrating an example of the recording data output waveform and how information is recorded to an optical disk in an embodiment;

FIG. 6 is a diagram of an example of the control data output waveform in an embodiment;

FIG. 7 is a diagram of an example of a laser driver internal register map in an embodiment;

FIG. 8 is a diagram of another example of a laser driver internal register map in an embodiment;

FIG. 9 is a block diagram of an example of the internal structure of the recording and reproduction control circuit in an embodiment;

FIG. 10 is a block diagram of an example of the internal structure of the laser driver pertaining to the present invention;

FIG. 11 is a block diagram of an example of the internal structure of the recording and reproduction control circuit and laser drive circuit pertaining to the present invention;

FIG. 12 is a diagram of examples of the waveform of a mode switching signal and a recording control signal during recording;

FIG. 13 is a diagram of other examples of the waveforms of a mode switching signal and a recording control signal during recording;

FIG. 14 is a diagram of other examples of the waveforms of a recording control signal during recording;

FIG. 15 is a block diagram of another example of the internal structure of the recording and reproduction control circuit pertaining to the present invention;

FIG. 16 is a diagram of an example of the control data output waveform in an embodiment;

FIG. 17 is a timing chart illustrating an example of the waveform during recording in an embodiment;

FIG. 18 is a block diagram of another example of the internal structure of the laser driver in an embodiment; and

FIG. 19 is a block diagram of yet another example of the internal structure of the laser driver in an embodiment.

### EXPLANATION OF REFERENCE

100051
1101 optical disk medium
1102 optical pick-up unit
1103 reproduction signal amplifier
1104 servo
1105 recording and reproduction control circuit
1106 laser driver
1107 disk motor
1108 recording control signal
1201 laser diode
1202 current drive component
1203 setting control component
1204 input component
1205 output component
1206 recording data generation component
1207 control data sending component
1208 flexible printed cable

### BEST MODE FOR CARRYING OUT THE INVENTION

An embodiment of the information recording device pertaining to the present invention will now be described through reference to the drawings.

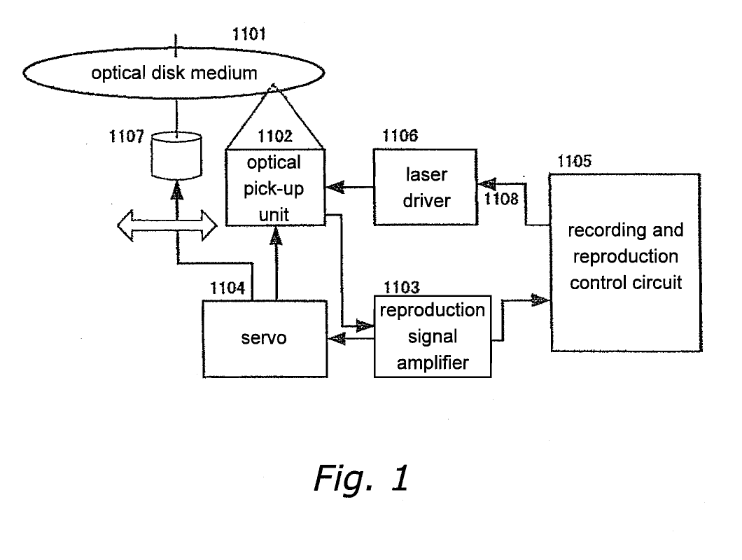

FIG. 1 is a block diagram of the structure of the optical disk recording device pertaining to the present invention. An optical disk medium 1101 has an information track (not shown here) in which a spiral guide groove has been formed ahead of time on the recording side where information is recorded and reproduced. Information including physical addresses for specifying positions on the optical disk medium is recorded by modulation in the guide groove.

While not shown in the drawing, an optical pick-up unit 1102 includes a laser light source device for outputting a laser beam, an optical system for focusing the laser beam outputted from the laser light source device onto the recording side of the optical disk medium 1101, and a light detector for detecting light reflected from the recording side on which the laser beam has been focused.

A reproduction signal amplifier 1103 amplifies an electrical signal corresponding to the reflected light detected by the optical pick-up unit 1102, filters out necessary signal components, which are then outputted to a servo 1104 and a recording and reproduction control circuit 1105.

The servo 1104 receives output from the reproduction signal amplifier 1103, and controls the positioning of the optical system of the optical pick-up unit 1102 so that the laser beam emitted by the optical pick-up unit 1102 will follow along the target information track. More specifically, a focus error signal or tracking error signal is detected from the output of the reproduction signal amplifier 1103, and an actuator (not shown) is driven to control the positioning of the optical pick-up unit 1102 so that the focal point of the laser beam will focus on the recording surface of the optical disk medium 1101 and follow along the information track. The disk motor 1107 is driven so as to rotate the optical disk medium 1101 at a specific speed.

The recording and reproduction control circuit 1105 receives the output of the reproduction signal amplifier 1103, reproduces a physical address that has been recorded ahead of time in the information track of the optical disk medium 1101, and seeks the target information track while working in conjunction with the servo 1104. Furthermore, after seeking the target physical address and finding it, this circuit records data to the information track or reads recorded data.

In recording data to the information track, the recording and reproduction control circuit 1105 receives data from an external source, modulates encoded data obtained by subjecting the received data to error correction encoding or other specific processing, and outputs a recording control signal 1108 to a laser driver 1106 according to the modulated data obtained by this modulation processing.

The laser driver 1106 receives the recording control signal 1108 and supplies current to a laser light source device (not shown) built into the optical pick-up unit 1102 and drives it so as to form the desired recording marks in the target information track of the optical disk medium 1101.

What is described above is an example of the basic constitution of the optical disk recording device pertaining to the present invention. The portion that is characteristic of the present invention will described in further detail through reference to another drawing.

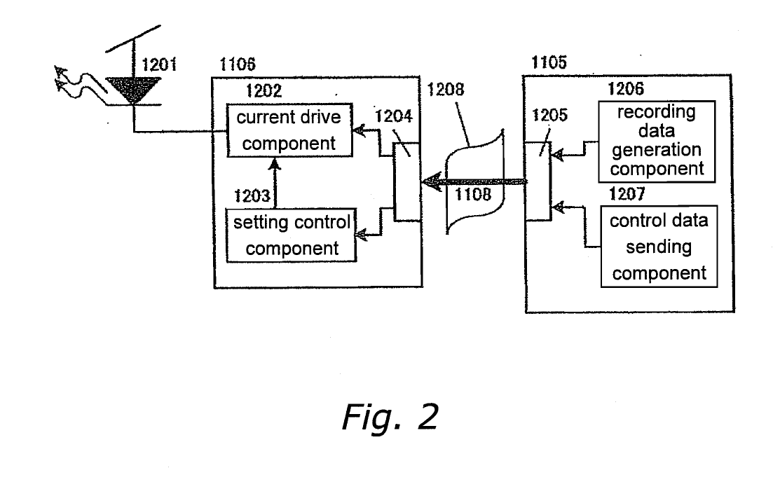

FIG. 2 is a block diagram showing an example of the structure of the recording and reproduction control circuit 1105, the laser driver 1106, and a laser diode 1201 that is a laser light source device in the optical disk recording device described through reference to FIG. 1.

An output component 1205, a recording data generation component 1206, and a control data sending component 1207 are incorporated into the recording and reproduction control circuit 1105. The function of the recording data generation component 1206 is to convert the information to be recorded into recording data that is a signal matching the recording principle, signal characteristics, and so forth of the optical disk. The process of converting the information to be recorded into recording data includes scrambling in which bias of the information bits is eliminated, error correction encoding for correcting errors that occur during recording and reproduction, recording modulation encoding to match the digital data to the signal characteristics of the optical disk, and so on. The function of the control data sending component 1207 is to generate and send various kinds of control data, such as drive current settings, to the laser driver 1106 so that the laser driver 1106 will properly drive the laser diode 1201 at the power level required for reproduction in the reproduction of information from the optical disk, and at the power level required for recording in the recording of information. The function of the output component 1205 is to multiplex as needed the recording data generated by the recording data generation component 1206 and the control data generated by the control data sending component, and output the data to the laser driver 1106 in the form of the recording control signal 1108.

A current drive component 1202, a setting control component 1203, and an input component 1204 are incorporated into the laser driver 1106. The function of the input component 1204 is to receive the recording control signal 1108 outputted by the recording and reproduction control circuit 1105, and allocate multiplexed recording data to the current drive component 1202, and control data to the setting control component 1203. The function of the setting control component 1203 is to receive control data included in the recording control signal 1108 from the input component 1204, hold it in a built-in register (not shown), and supply the contents of the control data to a current drive component as necessary. The contents of the control data are, for example, the setting of the drive current to be sent to the laser diode. The function of the current drive component 1202 is to receive the recording data included in the recording control signal 1108 from the input component 1204, and drive the laser diode 1201 with current according to the drive current setting, etc., set in the setting control component 1203.

This recording and reproduction control circuit 1105 is constituted as a system LSI. Meanwhile, the laser driver 1106 is incorporated into the optical pick-up unit 1102, which is a movable component, and is connected by the flexible printed cable 1208 to the recording and reproduction control circuit 1105, which is mounted to a fixed component, and the recording control signal 1108 is sent between the laser driver 1106 and the recording and reproduction control circuit 1105.

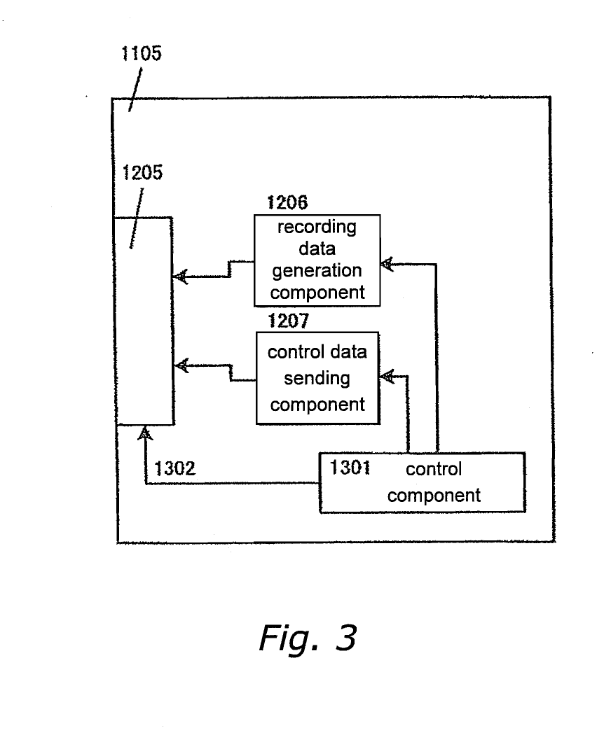

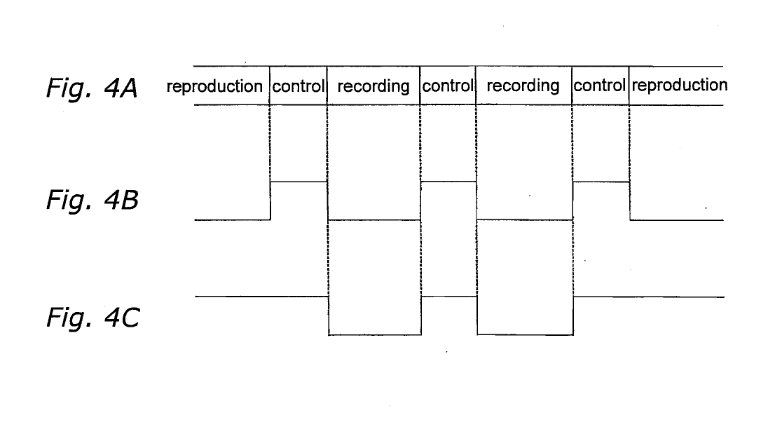

Next, an example of the recording and reproduction control circuit 1105 outputting the recording control signal 1108 in which recording data and control data have been multiplexed will be described using FIGS. 3 and 4.

FIG. 3 shows an example of the internal structure of the recording and reproduction control circuit 1105. In addition to the above-mentioned output component 1205, recording data generation component 1206, and control data sending component 1207, the recording and reproduction control circuit 1105 has a control component 1301 for the purpose of controlling these components as a whole. The control component 1301 suitably causes the generation of recording data, the sending of control data, and the multiplexing into a recording control signal to be performed according to the recording and reproduction of information. In particular, the control component 1301 generates a mode switching signal 1302 that selects whether to output recording data or to send control data, and sends this signal to the output component 1205.

FIG. 4 is a diagram of a timing example, and illustrates how the mode switching signal 1302 changes according to the recording and reproduction of information. The flow of time is from left to right in the drawing, and FIG. 4a shows the sequential progression from information reproduction, to laser driver control, to information recording, to control, to recording, to control, and to reproduction. FIG. 4b is an example of the output of the mode switching signal 1302. In this example, the output is at a high level during laser driver control, and is at a low level for the rest of the time. The control component 1301 sends this mode switching signal 1302 to the output component 1205, and the output component 1205 multiplexes and generates the recording control signal 1108 such that control data will be selected from the control data sending component 1207 when the mode switching signal 1302 is at a high level, and recording data will be selected from the recording data generation component when the mode switching signal 1302 is at a low level. Doing this results in the recording control signal 1108 being sent to the laser driver 1106 in a form in which the recording data and control data have been suitably multiplexed, and the laser driver 1106 is able to drive the laser diode so that the laser beam required for the recording and reproduction of information can be properly emitted.

FIG. 4c is another example of the output of the mode switching signal 1302. In this example, the output is at a low level during data recording, and is at a high level for the rest of the time. The control component 1301 sends this mode switching signal 1302 to the output component 1205, and the output component 1205 multiplexes and generates the recording control signal 1108 such that control data will be selected from the control data sending component 1207 when the mode switching signal 1302 is at a high level, and recording data will be selected from the recording data generation component when the mode switching signal 1302 is at a low level. Doing this results in the recording control signal 1108 being sent to the laser driver 1106 in a form in which the recording data and control data have been suitably multiplexed, and the laser driver 1106 is able to drive the laser diode so that the laser beam required for the recording and reproduction of information can be properly emitted.

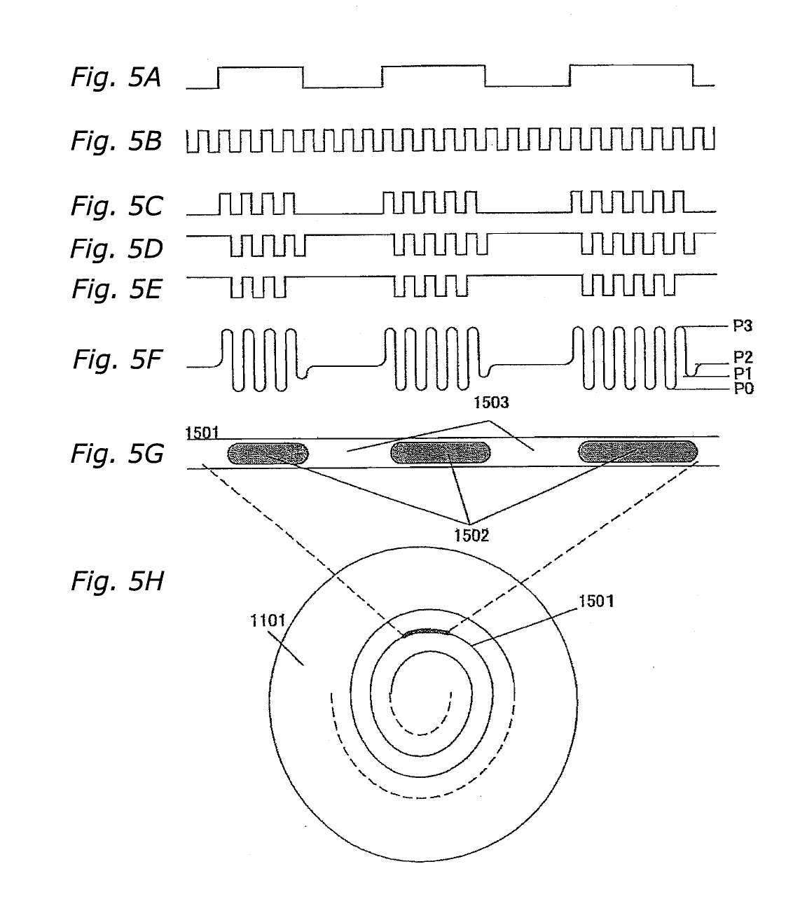

Next, an example of recording data output will be described. FIG. 5 shows a recording data output example, the power waveform of laser emission during recording corresponding to this output, and how information is recorded to the optical disk.

FIGS. 5a and 5b show examples of modulated data and a recording channel clock signal. The modulated data is digital data obtained by converting a known run-length limiting code to NRZI format; the high level of modulated data corresponds to a recording mark, and the low level to a recording space. The recording channel clock signal is a clock signal in which one channel bit period T of modulated data is termed one clock period, and the above-mentioned modulated data is synchronized to the rise timing of the recording channel clock signal. In the depicted example, the output sequence is a 4T mark, a 4T space, a 5T mark, a 4T space, and then a 6T mark.

Meanwhile, FIGS. 5c, 5d, and 5e show other examples using recording pulse signals. Recording pulse signals are a plurality of digital signals corresponding to the power waveform of laser emission during recording, and the point at which each level change occurs corresponds to the change in the laser power level of the power waveform of laser emission shown in FIG. 5f. In the power waveform of laser emission example shown in FIG. 5f, four laser power levels are specified, increasing in power from P0 to P3. The recording pulse (e) corresponds to a change from laser power level P0 to P1. The recording pulse (d) corresponds to a change from laser power level P1 to P2. The recording pulse (c) corresponds to a change from laser power level P2 to P3. In other words, the recording pulses {c, d, e}={low, low, low} correspond to the laser power level P0, the recording pulses {c, d, e}={low, low, high} correspond to the laser power level P1, the recording pulses {c, d, e}={low, high, high} correspond to the laser power level P2, and the recording pulses {c, d, e}={high, high, high} correspond to the laser power level P3, with the power waveform of laser emission being controlled according to the change in the recording pulse logic. FIG. 5g shows how recording marks 1502 are formed as the result of irradiating an information track 1501 of the optical disk with the laser beam so as to form this power waveform of laser emission. FIG. 5h is a plan view of the optical disk medium 1101 as viewed in the rotational axis direction. A spiral guide groove has been formed as the information track 1501 from the inner periphery toward the outer periphery. FIG. 5g is a detail view of a portion of this track. The series of changes to the power waveform of laser emission discussed above is called a multi-pulse train, which is a known technique for precisely forming the recording marks 1502. The portion of the information track 1501 other than the recording marks becomes the recording spaces 1503, which in this example correspond to irradiation at laser power level P2.

The above is a description of the flow from the output of recording data until the information is actually recorded to the optical disk.

The recording data outputted by the recording data generation component 1206 pertaining to this embodiment may be a recording channel clock signal and modulated data as shown in FIGS. 5a and 5b. When modulated data and a recording channel clock signal are multiplexed with the recording control signal 1108 and sent as the recording data, it is good for the laser driver 1106 on the receiving side to perform signal processing until the laser diode is driven so as to obtain a specific power waveform of laser emission, such as generating a specific recording pulse signal from the modulated data and recording channel clock signal.

Also, the recording data outputted by the recording data generation component 1206 may be the recording pulse signals shown in FIGS. 5c, 5d, and 5e. When a recording pulse signal is multiplexed with the recording control signal 1108 and sent as the recording data, it is good for the laser driver 1106 on the receiving side to perform signal processing until the laser diode is driven so as to obtain a specific power waveform of laser emission from the recording pulse signal.

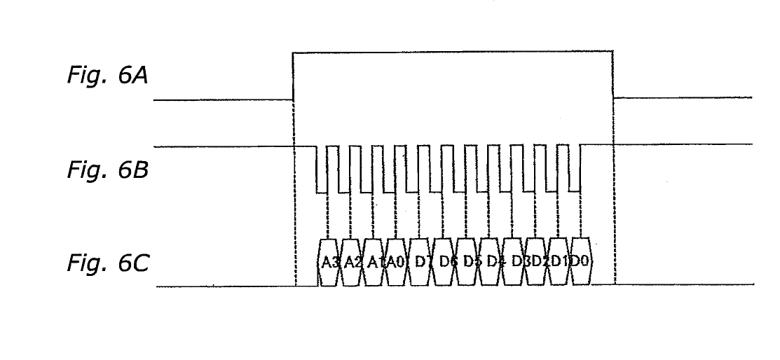

Next, an example of outputting control data will be described. FIG. 6 is a timing chart showing an example of control data output.

In the illustrated example, the control data is the product of putting together three signals consisting of the transfer enable signal in FIG. 6a, the transfer trigger signal in FIG. 6b, and the transfer data signal in FIG. 6c. FIG. 6a is the transfer enable signal and shows that data is transferred during a high level period thereof. FIG. 6b is the transfer trigger signal and shows the timing of obtaining the transferred data. FIG. 6c is the transfer data signal. The transfer data signal is updated in synchronization with the transfer trigger signal during the high level period of the transfer enable signal, and the contents of the transfer data are sent in a predetermined format.

An example of the transferred data format will now be described. In the example in FIG. 6, the transfer trigger signal is changed by 12 cycles during the transfer enable high period, and 12 bits of data are outputted as transfer data substantially in synchronization with the fall of the transfer trigger signal. Of the 12 bits of transfer data, the first four bits are addresses {A3, A2, A1, A0}, going from MSB to LSB, and the remaining eight bits are setting data {D7, D6, D5, D4, D3, D2, D1, D0}, from MSB to LSB. Using this format allows the settings to be expressed for a total of 128 bits, consisting of (4-bit address spaces: 16)×(8-bit setting data)=128 bits total. A corresponding register group of 8-bit register×16 addresses is incorporated into the laser driver.

Thus multiplexing control data consisting of a transfer enable signal, a transfer trigger signal, and formatted transfer data with the recording control signal 1108 and sending this multiplexed signal makes it possible to hold the signal in a setting register in the laser driver 1106 on the receiving side.

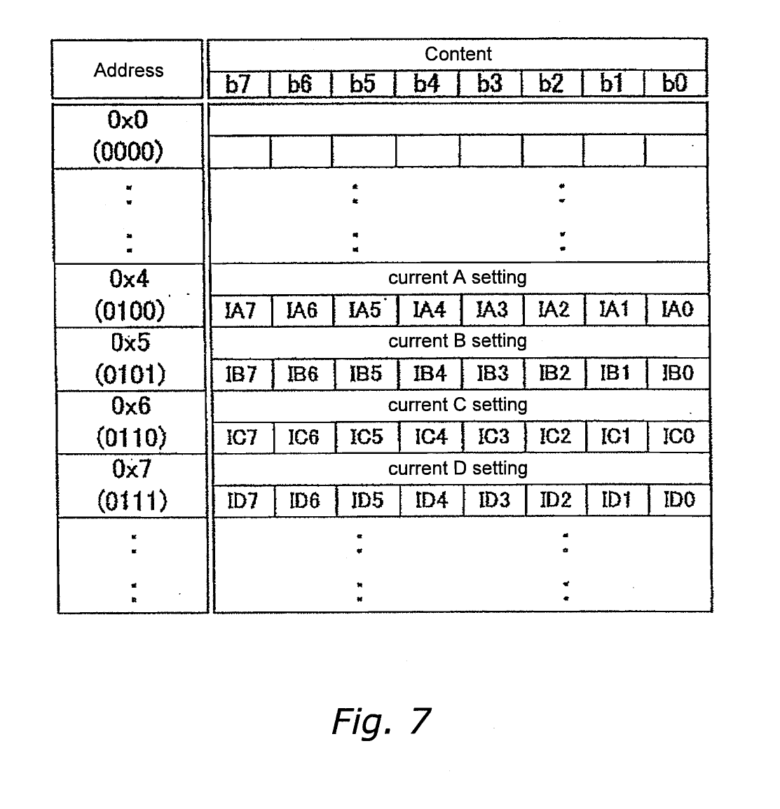

FIG. 7 shows an example of a register map of the contents of a setting register. In the example in FIG. 7, the setting contents are given as drive current settings A, B, C, and D of a laser diode. For example, we may consider that the drive current is determined by setting drive currents A, B, C, and D so that the laser diode will emit light at the laser power levels P0, P1, P2, and P3 described for FIG. 5f, and inputting this 8-bit code into a D/A converter built into the laser driver.

Let us describe this using as an example a method for generating control data for updating the drive current setting C to 89. Since the address of the drive current setting C is 0x6 (0110 in binary notation), A3=0, A2=1, A1=1, and A0=0, and since the setting value 89 is 01011001 in binary notation, D7=0, D6=1, D5=0, D4=1, D3=1, D2=0, D1=0, and D0=1. Since this should be transmitted in order, {0, 1, 1, 0, 0, 1, 0, 1, 1, 0, 0, 1} should be transmitted as the transfer data, synchronized with the transfer trigger signal during the high period of with transfer enable signal.

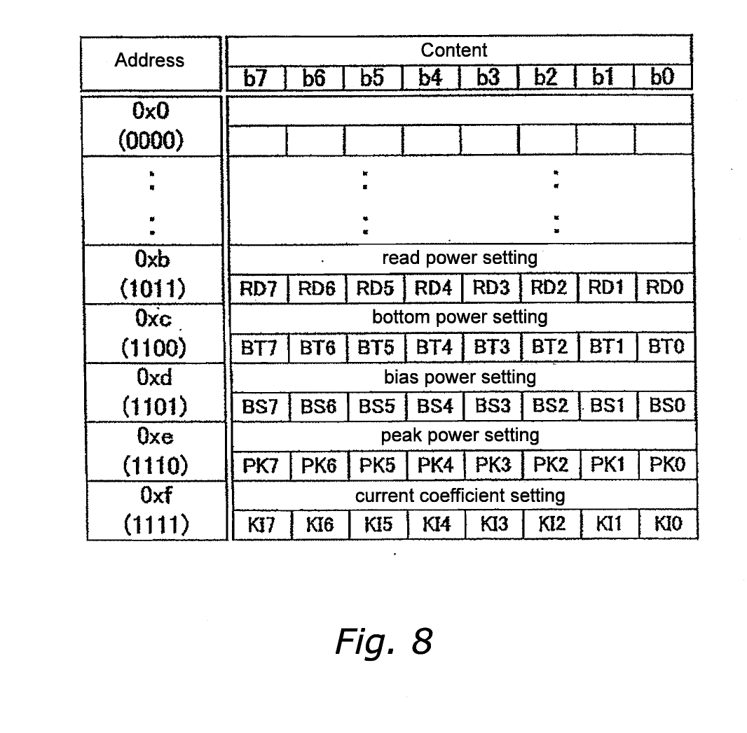

FIG. 8 shows another example of a register map of the contents of a setting register. In the example in FIG. 8, the setting contents are given as a read power setting, a bottom power setting, a bias power setting, and a peak power setting that determine the laser power level, and a current coefficient setting for converting these settings to drive current values for a laser diode. For example, let us assume that the read power setting RD[7:0] (indicating that this is an 8-bit digital value), the bottom power setting BT[7:0], the bias power setting BS[7:0], the peak power setting PK[7:0], and the current coefficient setting KI[7:0] are set for the laser diode to emit light at the laser power levels P0, P1, P2, and P3 described in FIG. 5f. For example, we may consider that the drive current for emission at power level P0=RD[7.0] ×KI[7.0], the drive current for emission at power level P1=BT[7.0]×KI[7.0], the drive current for emission at power level P2=BS[7.0]×KI[7.0], and the drive current for emission at power level P3=PK[7.0]×KI[7.0], and that the drive current is determined by inputting the 16-bit code of these current value calculation results into a D/A converter built into the laser driver.

The method for generating control data for updating these setting register values is the same as that in the case of FIG. 7, and will therefore not be described again.

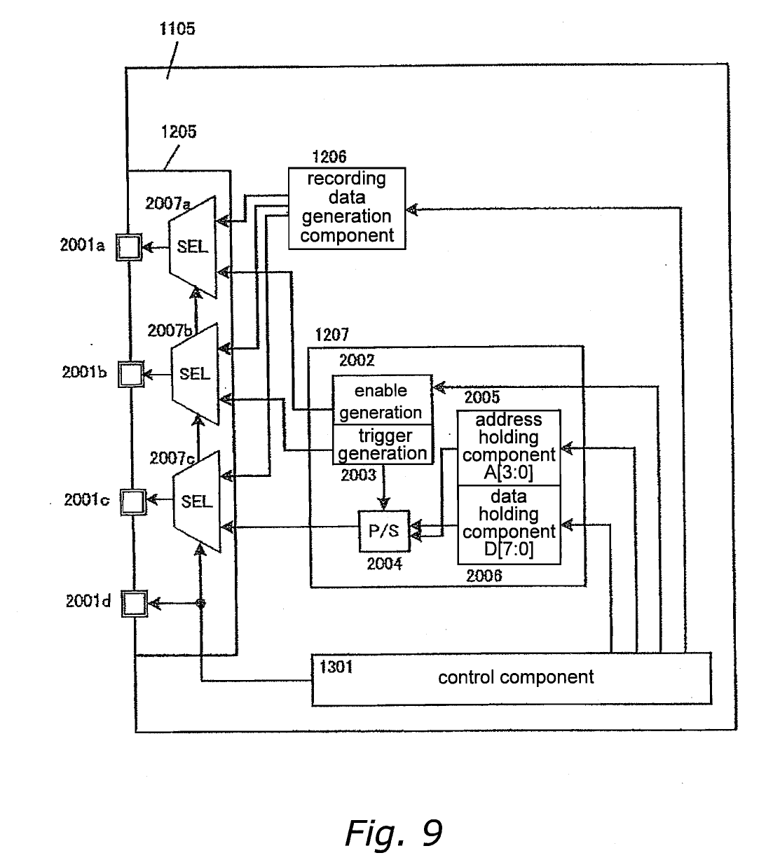

FIG. 9 shows an example of the internal structure of the recording and reproduction control circuit 1105, and more particularly an example of the detailed internal structure of the control data sending component 1207 that generates the above-mentioned control data. In the example shown here, the control data sending component 1207 includes an enable generation component 2002, a trigger generation component 2003, a parallel/serial converter 2004, an address holding component 2005, and a data holding component 2006.

The procedure for generating control data consisting of a transfer enable signal, a transfer trigger signal, and transfer data will now be described. The control component 1301 sets the 4-bit address value A[3:0] corresponding to the setting register map of the laser driver, and the 8-bit data value D[7:0] that is to be set, in the address holding component 2005 and the data holding component 2006, respectively. After this, the control component 1301 instructs the enable generation component 2002 to commence transfer. The enable generation component 2002 asserts the transfer enable signal to the high level upon receiving the instruction to commence transfer. The trigger generation component 2003 outputs 12 cycles of toggling of the transfer enable signal at a specific timing after the transfer enable signal has been asserted. The parallel/serial converter 2004 receives the address value A[3:0] and the data value D[7:0], and performs serial conversion in the order of {A3, A2, A1, A0, D7, D6, D5, D4, D3, D2, D1, D0} and outputs the result as transfer data in synchronization with the fall of the transfer enable signal. The enable generation component 2002 detects that the transfer trigger signal has completed 12 cycles of toggling, and after a specific time, negates the transfer enable signal to a low level. By performing the operation described above, control data can be generated at the timing described in FIGS. 6a, 6b, and 6c and outputted to selection components 2007a and 2007b, and 2007c incorporated into the output component 1205.

Meanwhile, upon receiving an instruction from the control component 1301 to commence recording, the recording data generation component 1206 generates recording data in a specific procedure, generates recording pulse signals such as those shown in FIGS. 5c, 5d, and 5e, and outputs these to the selection components 2007a, 2007b, and 2007c incorporated into the output component 1205. The control component 1301 outputs a mode switching signal to the selection components 2007a, 2007b, and 2007c incorporated into the output component 1205 at the timing shown in FIG. 4c, for example. The mode switching signal is then outputted to an external output terminal 2001d, and also transmitted to the laser driver 1106 as a selection signal for identifying whether control data or recording data is being outputted as a recording control signal.

The selection components 2007a, 2007b, and 2007c select the outputs from the recording data generation component 1206 when the mode switching signal is at a low level, and select the outputs from the control data sending component 1207 when the signal is at a high level, so that multiplexed signals are outputted as recording control signals to the external output terminals 2001a, 2001b, and 2001c, respectively. Thus, three outputs are transmitted as recording control signals through the external output terminals to the laser driver 1106.

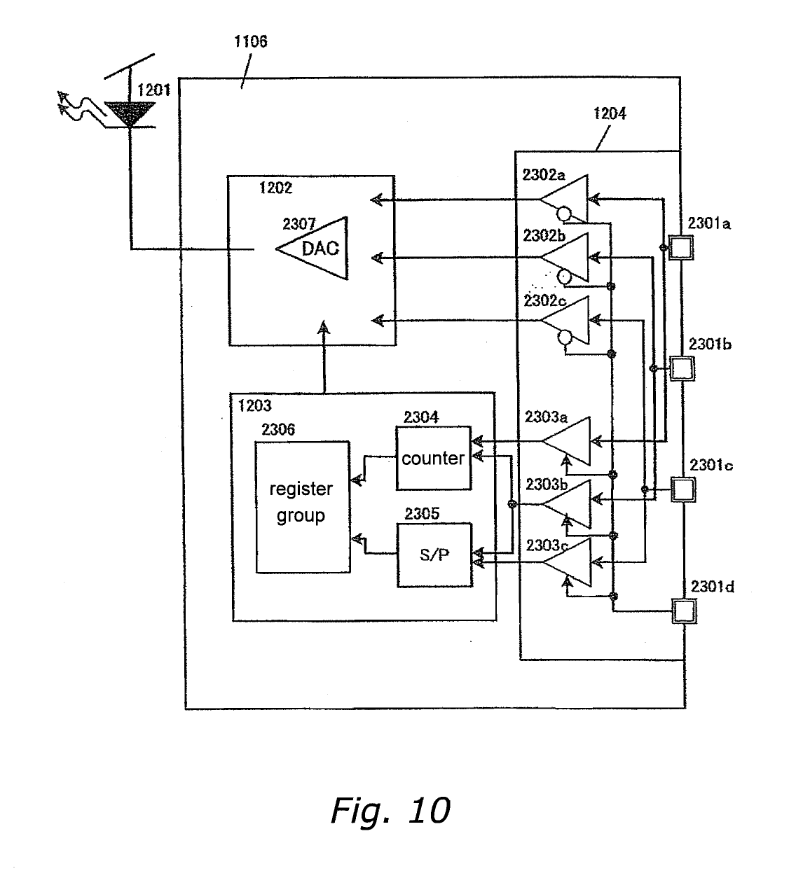

FIG. 10 shows an example of the internal structure of the laser driver 1106. This drawing will be used to describe an example of the operation after the receipt of the recording control signal outputs described above through reference to FIG. 9. Although not depicted, the external output terminals 2001a, 2001b, 2001c, and 2001d of the recording and reproduction control circuit 1105 described for FIG. 9 are respectively connected to external input terminals 2301a, 2301b, 2301c, and 2301d of the laser driver 1106 show in FIG. 10.

The input component 1204 includes first receivers 2302a, 2302b, and 2302c, and second receivers 2303a, 2303b, and 2303c. The first receivers 2302a, 2302b, and 2302c have as their inputs the recording control signals received from the external input terminals 2301a, 2301b, and 2301c, respectively, and these inputs are outputted without modification when the mode switching signal received from the external input terminal 2301d is at a low level, and the output is fixed low when the signal is at a high level. Conversely, the second receivers 2303a, 2303b, and 2303c have as their inputs the recording control signals received from the external input terminals 2301a, 2301b, and 2301c, respectively, and these inputs are outputted without modification when the mode switching signal received from the external input terminal 2301d is at a high level, and the output is fixed low when the mode switching signal is at a low level. Thus, the mode switching signal can be used as a selection signal to identify whether recording data or control data is inputted as the recording control signal, allowing each to be separated from the other.

The first receivers 2302a, 2302b, and 2302c output to the current drive component 1202 only the recording data separated as a result of the above. The second receivers 2303a, 2303b, and 2303c output to the setting control component 1203 only the control data separated as a result of the above.

The setting control component 1203 includes a counter 2304, a serial/parallel converter 2305, and a register group 2306. The operation in which control data is received and the setting register value of a specific address is updated will now be described. The counter 2304 receives the transfer enable signal that is the output of the second receiver 2303a, and the transfer trigger signal that is the output of the second receiver 2303b, and counts the rise of the transfer trigger signal while the transfer enable signal is in its high period. The serial/parallel converter 2305 receives the transfer trigger signal, and the transfer data signal that is the output of the second receiver 2303c, and the transfer data signals are successively latched at the timing of the rise of the transfer trigger signal, and a total of 12 bits are held. If we assume that the transfer data is transferred in the format shown in the example in FIG. 6, then it is held in the order of {A3, A2, A1, A0, D7, D6, D5, D4, D3, D2, D1, D0}, and the addresses A[3:0] and data D[7:0] are all specified. The register group 2306 is made up of registers of 16 addresses×8 bits, for a total of 128 bits. The addresses A[3:0] and data D[7:0] are specified by the transfer trigger signal rise on the twelfth cycle in the high period of a series of transfer enable signals, and at the same time the value of the data D[7:0] is written to the 8-bit register belonging to a specific address A[3:0].

The current drive component 1202 includes a D/A converter 2307. The digital value corresponding to the drive current to be applied to the laser diode 1201 is set in the D/A converter 2307, and current is supplied to the laser diode 1201 according to the setting. The input of the D/A converter 2307 is determined by the setting value held in the register group 2306 of the setting component 1203. Also, the drive current supplied to the laser diode 1201 is switched according to the recording data that is the output of the first receivers 2302a, 2302b, and 2302c, that is, the recording pulse signals shown in FIGS. 5c, 5d, and 5e.

Drive current can be switched by a number of different methods. Although not shown in the drawings, D/A converters may be provided in a number at least corresponding to the power level to be switched (four in the example of FIG. 51), the inputs of the plurality of D/A converters may be connected to a specific setting register incorporated into the setting component 1203, and the analog outputs of the D/A converters may be switched according to the logic of the recording pulse signals with a high-speed analog switch (not shown). Another possible method is to select a plurality of setting register values incorporated into the setting component 1203 according to the logic of the recording pulse signals, and input the selected values into a single D/A converter.

The output component 1205 in FIG. 9 and the input component 1204 in FIG. 10 are constituted such that the signals are transmitted through a single line by one-to-one external terminals, but as discussed below, the signals may instead be subjected to differential transmission with two lines.

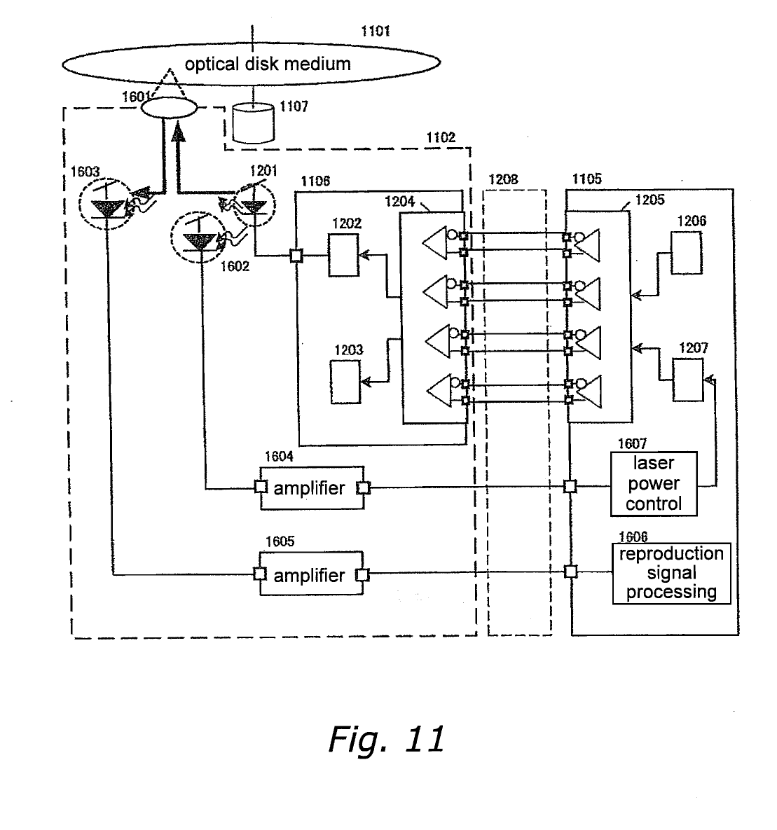

FIG. 11 shows an example of the structure when differential transmission is used. This example focuses on the internal structure of the recording and reproduction control circuit 1105 and the optical pick-up unit 1102, and on the signal lines connecting these, out of the overall structure of the optical disk recording device shown in FIG. 1.

The light emitted by the laser diode 1201 goes through an optical system 1601 and irradiates a specific information track on the optical disk medium 1101. The reflected light goes through the optical system 1601 and is received by a photodetector 1603, and the received current is amplified by an amplifier 1605 and transmitted as a reproduction RF signal to a reproduction signal processing system 1606. The reproduction signal processing system 1606 reproduces the necessary information from the reproduction RF signal.

Also, the light emitted by the laser diode 1201 is received directly by a photodetector 1602, and the received current is amplified by an amplifier 1604 and transmitted as a laser power detection signal to a laser power control system 1607. The laser power control system 1607 uses the laser power detection signal to control the drive current of the laser light source device 1201 so that the laser is always at a proper power level.

The output component 1205 has a built-in differential signal driver, and outputs a recording control signal in which recording data and control data are multiplexed, as four pairs (eight in total) of low amplitude differential signals. The input component 1204 has a built-in differential signal receiver, receives four pairs (eight in total) of low amplitude differential signals as recording control signals, and fetches recording data and control data respectively. The amplifiers 1604 and 1605 and the laser driver 1106 built into the optical pick-up unit 1102 are wired through the flexible printed cable 1208 to the recording and reproduction control circuit 1105 mounted on the main board, and this wiring carries not only the above-mentioned four pairs (eight total) of low amplitude differential signals, but also the laser power detection signal that is the output of the amplifier 1604 and the reproduction RF signal that is the output of the amplifier 1605.

An advantage to this use of differential transmission for the recording control signals is that there is less noise. In particular, common mode noise such as that which leaks in through the ground or the power supply can be canceled out by differential transmission, so noise suppression is markedly improved. Also, if this low noise advantage is utilized to perform low amplitude differential transmission of about 200 mV, not only will noise be suppressed in this signal, but noise sources can be eliminated from other signal transmission, and unnecessary radiation can be reduced.

Therefore, even when reproduction RF signals or laser power detection signals are transmitted by the same flexible cable as shown in this drawing, the signals will affect the characteristics of each other less. This is particularly advantageous when high-speed and high-precision pulse transmission is required in the time axis direction, such as with recording pulse signals, and this is an effective way to constitute a high-speed and high-quality optical disk recording device.

Next, a method for transmitting a recording control signal in which recording data and control data are multiplexed during a recording operation will be described.

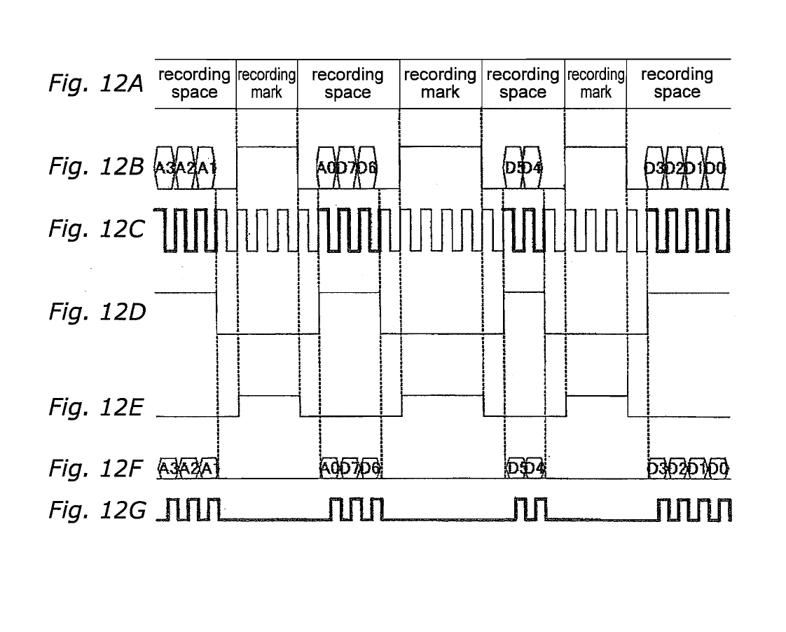

FIG. 12 shows examples of the waveform of a mode switching signal and a recording control signal during recording.

FIG. 12a shows how the period in which recording marks are formed and the period in which recording spaces are formed shift along with time during a recording operation. In particular, with the method in which the product of converting a run-length limiting code into NRZI format, which is known as a recording modulation method, is used as modulated data shown in FIG. 12e, the recording marks and recording spaces each continue for a specific period. This recording operation period composed of the recording mark formation period and the recording space formation period indicates the period in which recording is actually carried out, and does not include such things as a seek operation with the optical pick-up unit after receipt of a command for a recording operation.

FIG. 12c shows a recording channel clock signal. Assuming that T is one cycle of the recording channel clock signal, a recording mark is the high level period of modulated data, and a recording space is the low level period, then in the example shown in the drawing, modulated data including a 3T mark, a 5T space, a 4T mark, a 4T space, and a 3T mark is outputted as part of the recording operation. FIG. 12d shows a mode switching signal. The mode switching signal is set to the low level so as to cover at least the recording mark formation period.

FIG. 12b is a signal in which modulated data and control data have been multiplexed so that control data will be outputted when the mode switching signal is in the high level period, and modulated data will be outputted when the mode switching signal is in the low level period. Three bits, A3, A2, and A1, are superposed in the space period prior to the first 3T mark. Three bits, A0, D7, and D6, are superposed in the 5T space period after the 3T mark. Two bits, D5 and D4, are superposed in the 4T space period after the 4T mark. Four bits, D3, D2, D1, and D0, are superposed in the space period after the final 3T mark.

Thus, it is possible to split up and multiplex the control data by utilizing part of the period corresponding to the low period of the modulated data, that is, the recording space portions. In the case of this example, the period from which the head 1T and the tail 1T of each recording space period have been omitted is termed the high period of the mode switching signal, and a number of bits of control data corresponding to the number of channel clock signals in this period are outputted in synchronization with the recording channel clock signal. Even though the data is split up without forming a continuous series of control data, it is outputted in the order of {A3, A2, A1, A0, D7, D6, D5, D4, D3, D2, D1, D0}, then a series of control data sets can be sent at the point when the total of the mode switching signal high level periods reaches 12T. As a result, the setting register contents inside the laser drive circuit shown in the examples in FIGS. 7 and 8 can be updated.

The recording control circuit may output the signals shown in FIGS. 12b and 12c as recording control signals to the laser drive circuit, and output the signal shown in FIG. 12d as a mode switching signal.

The recording control circuit that performs this operation can have the same constitution as that described through reference to FIG. 9. Instead of a transfer enable signal, however, it is better if a mode switching signal is generated based on modulated data generated by the recording data generation component, and a transfer trigger signal is generated and setting data outputted during the high level period of the mode switching signal.

Also, if the cycle of the trigger signal is the same as that of the recording channel clock signal, then the recording channel clock signal shown in FIG. 12c may be used directly as an external output, without multiplexing the transfer trigger signal and the recording channel clock signal. This allows the recording channel clock signal to be used as a trigger signal, so the recording data generation component and the control data transmission component in the recording control circuit can be operated by clock signals of the same frequency. Therefore, the structure of the device can be simplified, and the multiplexing of the recording control signals shown in FIG. 12 can be accomplished more easily.

Meanwhile, the laser drive circuit that receives the recording control signal transmitted as above can have the same constitution as that described through reference to FIG. 10. Specifically, the setting control component 1203 may receive the inputted mode switching signal, a built-in counter is actuated, and the setting data received in the order of {A3, A2, A1, A0, D7, D6, D5, D4, D3, D2, D1, D0} undergoes parallel/serial conversion and is held in the desired register included in the register group.

If the counter operation is such that the recording channel clock signals are counted during the high period of the mode switching signal, and the operation continues for a loop of 12 clock cycles (looping at 0 to 11), then the setting data can be received even though it is not transferred as a continuous series as in the shown in FIG. 6.

Also, of the recording control signal shown in FIG. 12b, if the signal in the low level period of the mode switching signal is mask-controlled at the current drive component 1202 so that it is not considered modulated data, then just the modulated data can be suitably separated, and recording pulse signal generation and drive control of the laser light source device can be carried out in a way suited to the recording mark portion.

An advantage of this system is that laser power can be easily controlled even right in the middle of a data recording operation. With the system described through reference to FIGS. 6, 9, and 10, when laser power is controlled by means of control data including a transfer enable signal, a transfer trigger signal, and a transfer data signal, a plurality of bits (such as 12 bits) of data have to be transferred continuously in order to transfer a series of control data.

In this example, as described above, control data can be easily multiplexed and transferred even right in the middle of a data recording operation by using a period other than that of the recording mark portion to split up and send the control data.

Furthermore, in the above embodiment the multiplexing of the control data was accomplished by utilizing the period other than the recording mark portion, that is, the recording space formation period, but this is not always required when modulated data and recording channel clock signals are outputted as the recording data. The reason is that in the case of modulated data, the recording mark portions and recording space portions appear alternately during a recording operation, and the length and frequency of these periods are usually about the same, so there is no problem with conversely utilizing the recording space formation period to transfer control data.

However, when a recording pulse signal is outputted as the recording data, the points at which the recording pulse signal changes are concentrated in the recording mark portions, so it is difficult to superpose control data here, and it is more effective to utilize the period in which there is no change point of the recording pulse signal as described below, that is, a recording space period of at least a specific length.

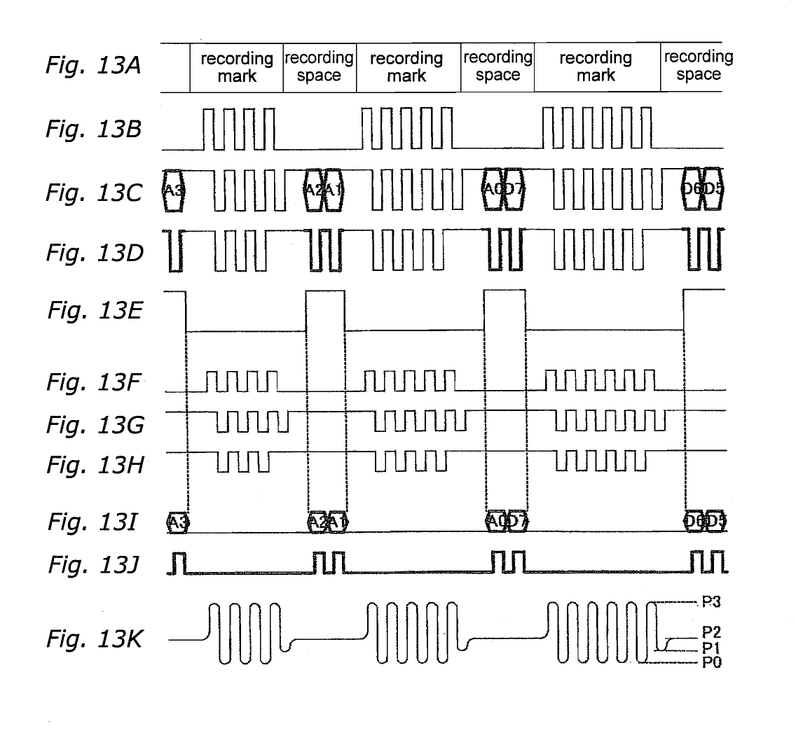

FIG. 13 shows other examples of the waveforms of a mode switching signal and a recording control signal during recording operation.

FIG. 13a shows how the period in which recording marks are formed and the period in which recording spaces are formed shift along with time during a recording operation. FIGS. 13b, 13c, and 13d show recording control signal in which recording data and control data are multiplexed, and FIG. 13e shows a mode switching signal. The recording data includes the recording pulse signals shown in FIGS. 13f, 13g, and 13h, which are multiplexed to the recording control signals shown in FIGS. 13b, 13c, and 13d, respectively. The control data includes the setting data shown in FIG. 13i and the transfer trigger signal shown in FIG. 13j, which are multiplexed to the recording control signals shown in FIGS. 13c and 13d, respectively.

Even when the recording data thus includes a recording pulse signal rather than modulated data, it is possible to transmit a recording control signal in which recording data and control data are multiplexed by utilizing a period with no change point for the recording pulse signal (recording space period) to superpose the control data.

Separating the recording data and control data, and updating a setting register on the basis of the control data, in a laser drive circuit may be accomplished by using a mode switching signal by the method discussed above through reference to FIG. 12. Therefore, this will not be described again.

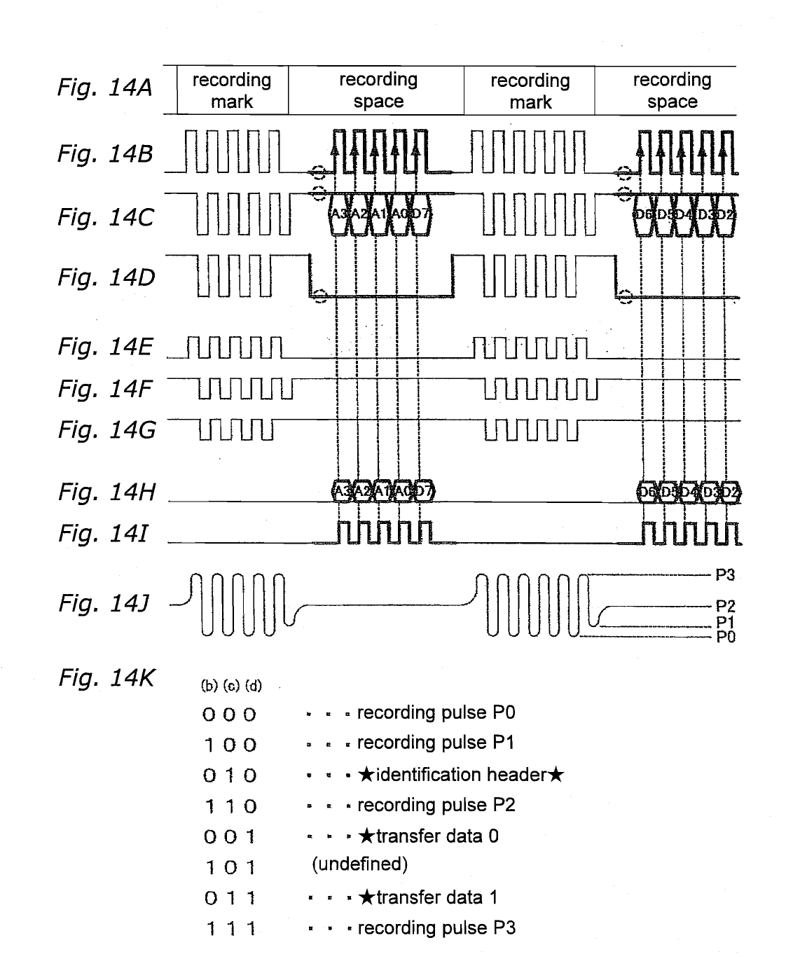

FIG. 14 shows other examples of the waveforms of a recording control signal during recording operation.

FIG. 14a shows how the period in which recording marks are formed and the period in which recording spaces are formed shift along with time during a recording operation. FIGS. 14b, 14c, and 14d show recording control signal in which recording data and control data are multiplexed. The recording data includes the recording pulse signals shown in FIGS. 14e, 14f, and 14g, which are multiplexed to the recording control signals shown in FIGS. 14a, 14b, and 14c, respectively. The control data includes the setting data shown in FIG. 14h and the transfer trigger signal shown in FIG. 14i, which are multiplexed to the recording control signals shown in FIGS. 14b and 14c, respectively.

The only difference between this example and the example in FIG. 13 is that no mode switching signal is used to identify the recording data and control data. Instead of using a mode switching signal, an identification header for identifying recording data and control data is multiplexed as a recording control signal. An identification header is expressed by setting recording control signals (b), (c), and (d) to low-high-low, respectively, in a specific period, and control data is superposed in the period from the start of the identification header until the recording control signal (d) changes from low to high.

The “recording control signals (b), (c), and (d)=low-high-low” here are values not defined as logic of recording pulse signals, and values that have not been defined as recording pulse signals are utilized for an identification header indicating the start of control data.

FIG. 14k shows the logic values of the recording control signals (b), (c), and (d) and the definitions thereof. 1 is the signal value at a high level, and 0 is a signal value at a low level. The four values “000,” “100,” “110,” and “111” are defined as recording pulse signals, and corresponding to the laser power levels P0, P1, P2, and P3, respectively. A distinction can be made from the logic value of a recording pulse signal here by defining “010,” which was not originally defined, as the value of an identification header.

By sending a recording control signal in which this identification header has been multiplexed, it is possible to identify and separate recording data and control data merely by detecting the identification header with the laser drive circuit on the receiving side, without having to transmit a separate mode switching signal.

The recording control circuit inserts an identification header by utilizing a period with no change point for the recording pulse signal (recording space period). More specifically, the recording pulse logic of the recording space portions is changed from low-high-high to low-high-low. In other words, the identification header is started by changing the recording control signal (d) to low, so that the start of the recording control signals (b), (c), and (d) changes from low-high-high to low-high-low. Thereafter, the recording control signal (a) is toggled by the transmittable number of bits, taking into account the length of the recording space period, to obtain a transfer trigger signal (five times each in the example shown in FIG. 14). Setting data is superposed with the recording control signal (b) in synchronization with the transfer trigger signal. When the transmittable number of bits have been transferred, the state of recording control signals (b), (c), and (d)=low-high-low is continued for a specific period, after which the recording control signal (d) is returned to high so that the state is low-high-high. The above sequence may be controlled so as to conclude within the recording space period.

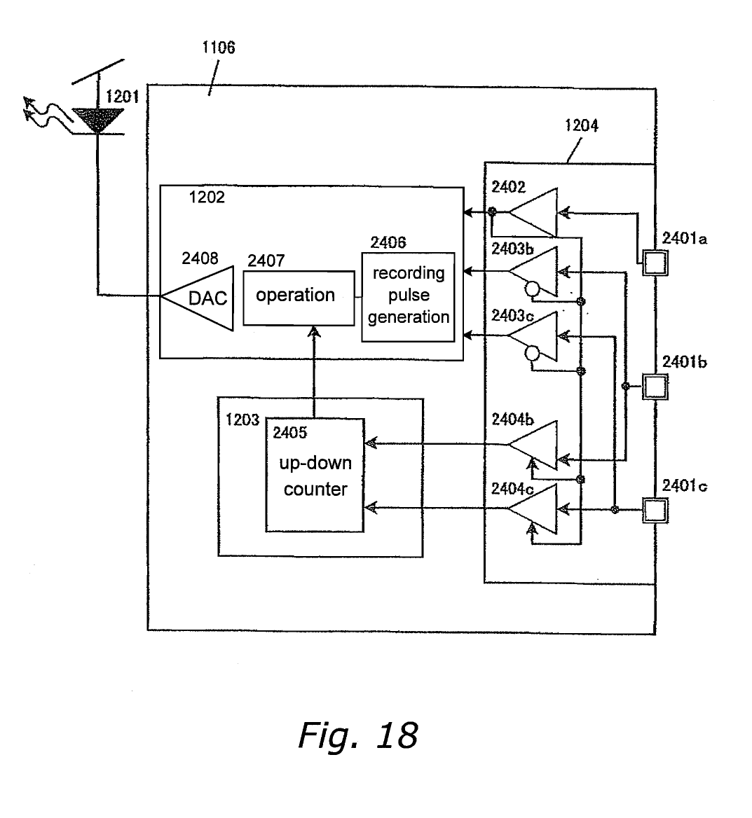

Meanwhile, the laser drive circuit detects a state of the recording control signals (b), (c), and (d)=low-high-low as an identification header, and from then until the recording control signal (d) changes from low to high, the received recording control signals (b) and (c) are interpreted to be control data, and the fetching of setting data is performed. The method for fetching the setting data is the same as that in the examples of FIGS. 12 and 18, and will therefore not be described again.

Conversely, if a change in the recording control signals (b), (c), and (d) in the above period is interpreted not to be recording data, this is masked and separated as recording data, that is, recording pulse signals. More specifically, from the point when a state of the recording control signals (b), (c), and (d)=low-high-low is detected until the recording control signal (d) changes from low to high, the value is held at the immediately prior value, that is, fixed at recording pulse logic=low-high-high.

As described above, the identification of recording data and control data is possible by multiplexing an identification header with recording control signals, and there is no need for a mode switching signal to be sent separately. By using logic not defined as recording data as an identification header, it is possible to detect this logic as an identification header and separate recording data from control data with a simple constitution.

An advantage of this system is also in that laser power can be easily controlled right in the middle of a data recording operation. Just as with the system shown in FIGS. 12 and 13, control data can be easily multiplexed and transferred even in the middle of data recording by splitting up and sending the control data by utilizing a period other than that of the recording mark portions.

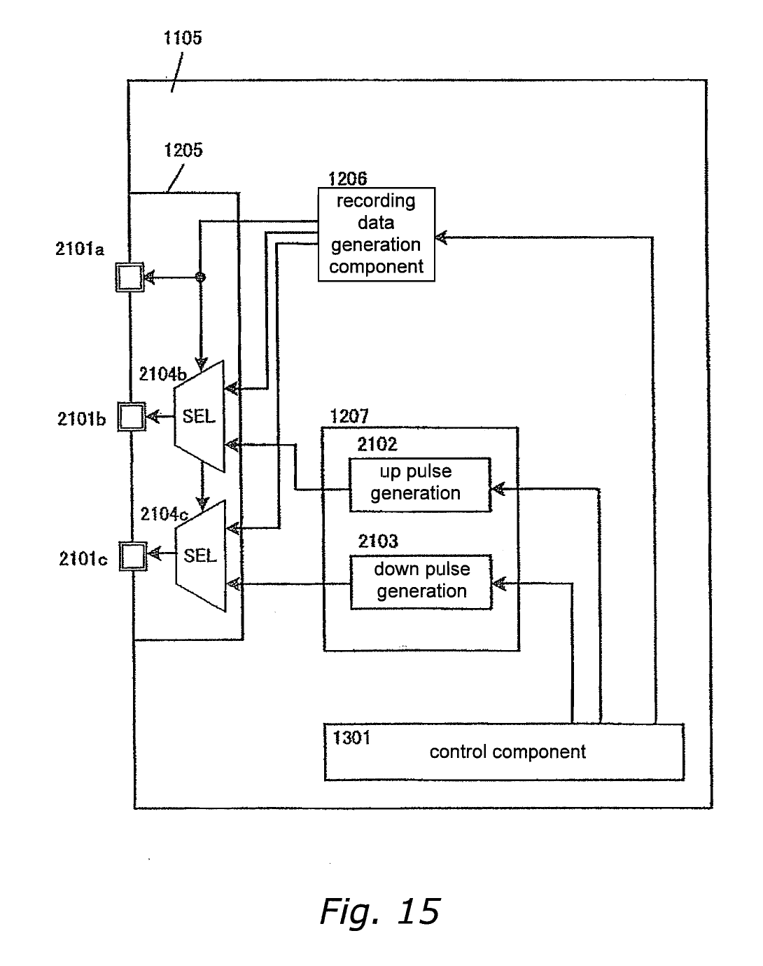

FIG. 15 shows another example of the internal structure of the recording and reproduction control circuit 1105, and more particularly the detailed internal structure of the control data sending component 1207 with which the control method is implemented in a different form than that for the control data discussed above. In the example shown here, the control data sending component 1207 includes an up pulse generation component 2102 and a down pulse generation component 2103. The up pulse generation component 2102 generates an up pulse signal that tells the laser driver to increase the drive current to the laser diode. The down pulse generation component 2103 generates a down pulse signal that tells the laser driver to decrease the drive current to the laser diode.

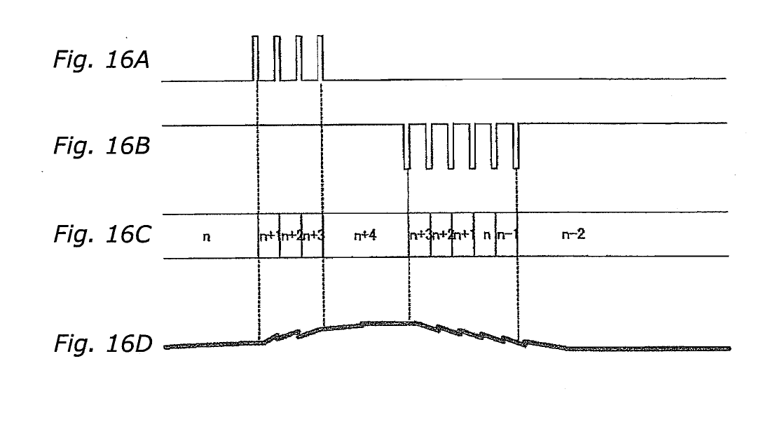

FIG. 16 shows an up pulse signal, a down pulse signal, and how the amount of drive current changes over time as a result of these. FIG. 16a shows an up pulse signal, and the application of a pulse signal at a high level tells the laser driver to increase the drive current. FIG. 16b shows a down pulse signal, and the application of a pulse signal at a low level tells the laser driver to decrease the drive current. FIG. 16c shows digital values corresponding to the amount of drive current, and shows how these values vary depending on the application of an up pulse signal or down pulse signal. That is, in the example shown here, the digital value is incremented by one when a single up pulse signal is applied, and the digital value is decremented by one when a single down pulse signal is applied. FIG. 16d shows analog values corresponding to the amount of drive current, and shows how these values vary depending on the application of an up pulse signal or down pulse signal, just as with the digital values in FIG. 16c.

Since the amount of drive current applied to the laser diode can be varied by thus using up pulse signals and down pulse signals, these can be used to control changes in the laser power. Conversely, if the emission power characteristics (I-L characteristics) of the laser diode with respect to the applied current vary with changes in heat, the ambient temperature, and so forth, then it is also possible to control the amount of drive current so that the laser power is kept constant.

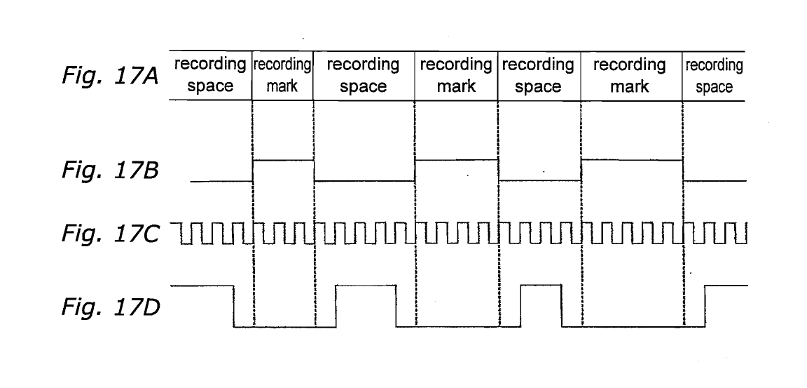

In the example shown in FIG. 15, the recording data generation component 1206 outputs a mode switching signal, modulated data, and a recording channel clock signal to the output component 1205. FIG. 17 shows examples of the waveforms thereof (during a recording operation). FIG. 17a shows the period in which recording marks are formed and the period in which recording spaces are formed shift along with time during a recording operation. The modulated data shown in FIG. 17b is the product of converting a run-length limiting code into NRZI format, which is known as a recording modulation method, and the recording marks and recording spaces each continue for a specific period. FIG. 17c shows a recording channel clock signal, and if we let T be one cycle of this signal, then in the example shown in the drawing, modulated data including a 3T mark, a 5T space, a 4T mark, a 4T space, and a 5T mark is outputted as part of the recording operation. FIG. 17d shows a mode switching signal. The mode switching signal is set to the low level so as to cover at least the recording mark formation period. When a series of multi-pulse signals such as those shown in FIGS. 5c, 5d, and 5e are used to form a single recording mark, the mode switching signal may be set to the low level for a period that will cover at least this series of multi-pulse signals.

The recording data generation component 1206 outputs the mode switching signal thus generated to an external terminal 2101a incorporated into the output component 1205. Also, modulated data and a recording channel clock signal are outputted to selection components 2104a and 2104b incorporated into the output component 1205. The up pulse signals and down pulse signal that are the output of the control data sending component 1207 are also outputted to the selection components 2104a and 2104b incorporated into the output component 1205.

The selection components 2104a and 2104b operate such that the recording channel clock signal and modulated data from the recording data generation component are selected when the mode switching signal is at a low level, and the up pulse signals and down pulse signals from the control data sending component are selected when the mode switching signal is at a high level, and are outputted to external terminals 2101b and 2101c. This makes it possible to send a recording control signal in which recording data and control data are multiplexed from the external terminals 2101b and 2101c to the laser driver 1106.

FIG. 18 shows another example of the internal structure of the laser driver 1106. This drawing will be used to describe an example of the operation after the receipt of the recording control signal output described above through reference to FIG. 15. Although not depicted, the external output terminals 2101a, 2101b, and 2101c of the recording and reproduction control circuit 1105 described for FIG. 15 are respectively connected to external input terminals 2401a, 2401b, and 2401c of the laser driver 1106 shown in FIG. 18.

The input component 1204 includes a first receiver 2402, second receivers 2403b and 2403c, and third receivers 2404b and 2404c. The first receiver 2402 sends the mode switching signal received from the external input terminal 2401a to the current drive component 1202 and to the second receivers 2403b and 2403c and third receivers 2404b and 2404c. The second receivers 2403b and 2403c have as their inputs the recording control signals received from the external input terminals 2401b and 2401c, respectively, and these inputs are outputted without modification when the mode switching signal from the first receiver 2402 is at a low level, and the output is fixed low when the signal is at a high level. Conversely, the third receivers 2404b and 2404c have as their inputs the recording control signals received from the external input terminals 2401b and 2401c, respectively, and these inputs are outputted without modification when the mode switching signal received from the first receiver 2402 is at a high level, and the output is fixed low when the signal is at a low level. Thus, the mode switching signal can be used as a selection signal to identify whether recording data or control data is inputted as the recording control signal, allowing each to be identified and separated from the other.

The second receivers 2403b and 2403c output to the current drive component 1202 only the recording data separated as a result of the above. The third receivers 2404b and 2404c output to the setting control component 1203 only the control data separated as a result of the above.

The setting control component 1203 includes an up-down counter 2405. The up-down counter 2405 receives up pulse signals and down pulse signals received as control data from the third receivers 2404b and 2404c, and operates so that the count is incremented by one by the rise of an up pulse signal, and is decremented by one by the rise of a down pulse signal. The initial value of the counter may be set separately, or may be fixed at a specific value. Doing this makes it possible to use up pulse signals and down pulse signals to control the digital values corresponding to the drive current described for FIGS. 16a, 16b, and 16c.

The digital values that are the output of the up-down counter 2405 are sent to the current drive component 1202. The current drive component 1202 includes a recording pulse generation component 2406, an operation component 2407, and a D/A converter 2408. The recording pulse generation component 2406 receives the modulated data and recording channel clock signals received as recording data from the second receivers 2403b and 2403c, and generates recording pulse signals that control the change point of the recording power waveform of laser emission. The recording pulse signals thus generated may be those described for FIGS. 5c, 5d, and 5e. The operation component 2407 generates digital power values corresponding to the power levels of the power waveforms of laser emission from the recording pulse signals obtained from the recording pulse generation component 2406 and the counter output values of the up-down counter 2405. The digital power level may be computed, for example, by switching the product of multiplying the counter output value by a specific value corresponding to a plurality of laser power levels, for every logic of the recording pulse signal. The plurality of specific values corresponding to the plurality of laser power levels may be fixed or may be made variable by separate settings. The D/A converter 2408 converts the digital power values from the operation component 2407 into analog current values and supplies them to the laser diode 1201.

With this constitution, it is possible to control the drive current of the laser diode so as to obtain a specific power waveform of laser emission, by using a recording control signal in which control data including an up pulse signal and a down pulse signal is multiplexed.

An advantage of this system is also in that laser power can be easily controlled even right in the middle of a data recording operation.

With the system described through reference to FIGS. 6, 9, and 10, when laser power is controlled by means of control data including a transfer enable signal, a transfer trigger signal, and a transfer data signal, a plurality of bits (such as 12 bits) of data have to be transferred continuously in order to transfer a series of control data.

With the system described in this example in which up pulse signals and down pulse signals are used, the two pulse signals can be split up and sent in a plurality of recording space periods, so the transfer of control data can be easily multiplexed even right in the middle of data recording.

Meanwhile, a system for transferring control data including a transfer enable signal, a transfer trigger signal, and transfer data signal is suited to when various kinds of control are performed using a setting register with a wide address space, so it is more effective to combine both systems.

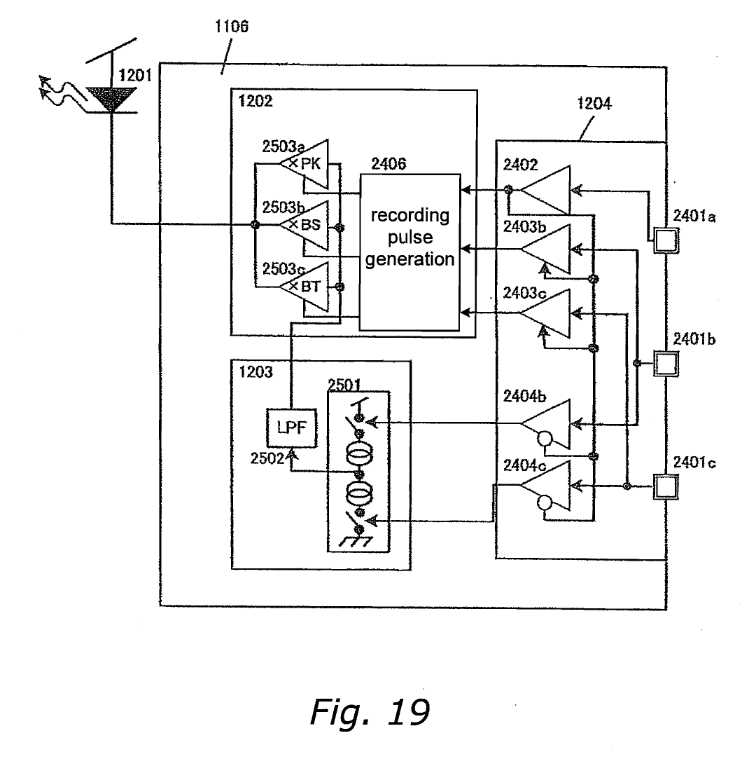

FIG. 19 shows another example of the internal structure of the laser driver 1106. The internal structure elements in FIG. 19 that are numbered the same as those described for FIG. 18 have the same function and operation, and will therefore not be described again. The principle difference in the structure of FIG. 19 versus that of FIG. 18 is that whereas the structure in FIG. 18 comprised digital signal processing including an up-down counter and a computer, the structure in FIG. 19 comprises analog signal processing including a charge pump and a low-pass filter. The operation will now be described.

The setting control component 1203 includes a charge pump 2501 and a low-pass filter 2502. The charge pump 2501 receives up pulse signals and down pulse signals from the third receivers 2404b and 2404c, and outputs current. The amount of output current is increased when a high pulse is applied as the up pulse signal, and the amount of output current is decreased when a low pulse is applied as the down pulse signal. The low-pass filter 2502 serves to smooth out noise by removing the high-band component of the output current of the charge pump 2501.

The current drive component 1202 includes the recording pulse generation component 2406 and current amplifiers 2503a, 2503b, and 2503c. The output of the low-pass filter 2502 is applied to the inputs of the current amplifiers, where the current is amplified at a specific gain (amplification ratio) and outputted. The amplification ratios of current amplifiers 2503a, 2503b, and 2503c are PK, BS, and BT, respectively, and are either fixed values or variable settings. The same recording pulse signals as those shown in FIGS. 5c, 5d, and 5e are outputted from the recording pulse generation component 2406, and are connected to the current amplifiers 2503a, 2503b, and 2503c, respectively. The current amplifiers 2503a, 2503b, and 2503c output amplified current only when the recording pulse signal to which they are connected is at a high level, and block off current when the level is low.

With this constitution, it is possible to control the drive current of the laser diode so as to obtain a specific power waveform of laser emission, by using a recording control signal in which control data including an up pulse signal and a down pulse signal is multiplexed.

Described above were the constitution of a recording control circuit that generates and sends a recording control signal in which are multiplexed recording data including information to be recorded and control data for performing laser power control and the like, the constitution of a laser drive circuit that receives a recording control signal and drives a laser beam oscillation device using control data and recording data extracted from the received recording control signal, and the constitution of an optical disk recording device that includes these.

Furthermore, the constitution related to an optical disk recording device in an embodiment of the present invention was described, but it should go without saying that the present invention can be applied to many different kinds of information recording device that make use of both recording data including information to be recorded and control data for performing recording properly, in order to record information to a recording medium, such as opto-magnetic disk devices and magnetic disk devices.

Also, the operations of the recording data generation component, control data generation component, and so forth described in the embodiments of the present invention may be executed by a computer program.

Part of the optical disk recording device described in the above embodiment may be made into a single chip by means of an LSI chip or other such semiconductor device. For example, the recording and reproduction control circuit in FIG. 1 may be made into a single chip, or this recording and reproduction control circuit, a reproduction signal amplifier, and a servo may be made into a single chip.

The term “LSI chip” was used here, but depending on the degree of integration, this may also be referred to as an IC, system LSI, super-LSI, or ultra-LSI.

Also, the method for circuit integration is not limited to LSI, and may instead be accomplished by a dedicated circuit or a multipurpose processor. After the manufacture of an LSI chip, an FPGA (Field Programmable Gate Array) that can be programmed, or a configurable processor that allows the reconfiguration of settings or connections of circuit cells inside an LSI chip, may be utilized.

Furthermore, if some new circuit integration technology that supplants LSI should debut as the result of another technique derived or advanced from semiconductor technology, then naturally this technology may be used to integrate function blocks. It is also conceivable that the application of biotechnology or the like may be possible.

In addition, none of the specific constitutions or specific numbers described or mentioned in this embodiment is intended to limit the present invention. The present invention is limited only by the patent claims.

### INDUSTRIAL APPLICABILITY

The present invention relates to an information recording device that records information by using a semiconductor laser or other such laser light source device to irradiate an information recording medium with a laser beam, and more particularly relates to a laser drive device for driving a laser light source device, to a recording control device for generating a recording control signal including information to be recorded and outputting this signal to a laser drive device, and to a method for transmitting signals from a recording control device to a laser drive device.

1. A recording control device for outputting a recording control signal to a laser drive device for driving a laser light source device to record information to an optical disk, comprising:
a recording data generation component operable to generate recording data including information to be recorded to the optical disk;
a control data generation component operable to generate control data that controls the laser drive device;
an output component operable to output the recording control signal in which the recording data and the control data are multiplexed; and
a control component operable to control at least one of the recording data generation component, the control data generation component, and the output component.

2. The recording control device according to claim 1,
wherein the control component generates a mode switching signal for selecting either to output the recording data or to output the control data, and
the output component selectively outputs the recording data and the control data according to the mode switching signal.

3. The recording control device according to claim 1,
wherein the output component further outputs a selection signal for making it possible to distinguish whether the recording data is being outputted or the control data is being outputted.

4. The recording control device according to claim 1,
wherein the control component controls operation such that the output component selects the control data in a period at least excluding a recording operation period in which information is recorded to the optical disk.

5. The recording control device according to claim 1,
wherein the control component controls operation such that the output component selects the control data at least during a recording operation period in which information is recorded to the optical disk and a period in which recording marks are not formed.

6. The recording control device according to claim 1,
wherein the control component generates a recording gate signal at least indicating a recording operation period in which information is recorded to the optical disk,
the recording data generation component generates recording data on the basis of the recording gate signal, and
the output component outputs the recording data during the recording operation period on the basis of the recording gate signal, and outputs the control signal so that the control data will be outputted except during the recording operation period.

7. The recording control device according to claim 1,
wherein the control component controls the control data generation component and the output component so that the control data will be split up and transferred.

8. The recording control device according to claim 1,
wherein the control component generates an identification header for making it possible to distinguish between the recording data and the control data from the multiplexed recording control signal, and
the output component outputs the recording control signal containing the identification header.

9. The recording control device according to claim 1,
wherein the recording data generation component generates the recording data so as to include modulated data that has been modulated according to a specific rule, and a clock signal synchronized to the modulated data.

10. The recording control device according to claim 1,
wherein the recording data generation component generates the recording data so as to include a pulse signal that controls a power waveform of laser emission in the recording of information to the optical disk.

11. The recording control device according to claim 1,
wherein the control data generation component generates the control data so as to include setting data held in the laser drive device, a trigger signal indicating the timing at which the laser drive device is to hold the setting data, and an enable signal indicating the transmission period of the setting data.

12. The recording control device according to claim 1,
wherein the control data generation component generates the control data so as to include a power setting code for controlling the laser emission power level in the recording of information to the optical disk.

13. The recording control device according to claim 1,
wherein the control data generation component generates the control data so as to include a current value setting code for controlling a drive current value for the laser light source device in the recording of information to the optical disk.

14. The recording control device according to claim 1,
wherein the control data generation component generates the control data so as to include a drive current amount control signal for controlling the increase and decrease of the amount of drive current for the laser light source device in the recording of information to the optical disk.

15. The recording control device according to claim 1,
wherein the output component comprises a differential signal driver circuit for subjecting the recording control signal to low amplitude differential output.

16. A laser drive device, for driving a laser light source device to record information to an optical disk, comprising:
an input component operable to receive a recording control signal in which recording data including information to be recorded to the optical disk and control data for controlling the laser drive device are multiplexed, and fetch the control data and the recording data from the recording control signal respectively;
a control data holding component operable to hold the control data; and
an output component operable to output a drive signal for driving the laser light source device on the basis of the recording data and the control data.

17. The laser drive device according to claim 16,
wherein the input component further receives a selection signal for making it possible to distinguish between the recording data and the control data, and fetches the control data from the recording control signal on the basis of the selection signal.

18. The laser drive device according to claim 16,
wherein the recording control signal includes an identification header for making it possible to distinguish between the recording data and the control data, and
the input component fetches the control data from the recording control signal by detecting the identification header.

19. The laser drive device according to claim 16,
wherein the control data includes at least setting data to be held in the control data holding component, a trigger signal indicating the timing for holding the setting data, and an enable signal indicating the transmission period of the setting data, and
the control data holding component holds the setting data on the basis of the trigger signal and the enable signal.

20. The laser drive device according to claim 16,
wherein the control data includes at least a power setting code for controlling the laser emission power level in the recording of information to the optical disk,
the control data holding component holds the power setting code included in the control data, and
the output component varies the drive signal level of the laser light source device on the basis of the power setting code.

21. The laser drive device according to claim 16,
wherein the control data includes at least a current value setting code for controlling a drive current value for the laser light source device in the recording of information to the optical disk,
the control data holding component holds the current value setting code included in the control data, and
the output component varies the drive current value of the laser light source device on the basis of the held current setting code.

22. The laser drive device according to claim 16,
wherein the control data includes at least a drive current amount control signal for controlling the increase and decrease of the amount of drive current for the laser light source device in the recording of information to the optical disk, and
the output component increases or decreases the drive current amount of the laser light source device on the basis of the drive current amount control signal included in the control data.

23. The laser drive device according to claim 16,
wherein the recording control signal is transmitted as a low amplitude differential signal, and
the input component comprises a differential signal receiver circuit for receiving the low amplitude differential signal.

24. An information recording device for recording information to an optical disk, comprising:
a recording control device having a recording data generation component operable to generate recording data including information to be recorded to the optical disk, a control data generation component operable to generate control data that controls a laser drive device, an output component operable to output a recording control signal in which the recording data and the control data are multiplexed, and a control component operable to control at least one of the recording data generation component, the control data generation component, and the output component;
a laser drive device having an input component operable to receive the recording control signal outputted from the recording control device, and fetch the control data and the recording data from the recording control signal respectively, a control data holding component operable to hold the control data, and an output component operable to output a drive signal on the basis of the recording data and the control data; and
a laser light source device configured to be driven by the drive signal, for irradiating the optical disk with a laser beam.

25. A method for signal transmission between a recording control device which generates and transmits recording data including information to be recorded to an optical disk and control data for controlling a level of a laser beam directed at the optical disk, and a laser drive device for driving a laser light source device for irradiating the optical disk with the laser beam, in an information recording device for recording information by irradiating the optical disk with the laser beam,
wherein a recording control signal in which the recording data and the control data are multiplexed is transmitted from the recording control device to the laser drive device.

26. A method for signal transmission between a laser drive device for driving a laser light source device that irradiates an optical disk with a laser beam, a detection device for detecting as an electrical signal the reflected light of the laser beam directed at the optical disk, and a recording and reproduction control device that generates recording data including information to be recorded to the optical disk and control data for controlling a level of the laser beam directed at the optical disk, sends the recording data and control data to the laser drive device, receives electrical signal from the detection device, and reproduces information, in an information recording device for recording and reproducing information by irradiating the optical disk with the laser beam,
wherein a recording control signal in which the recording data and the control data are multiplexed is transmitted as a low amplitude differential signal from the recording and reproduction control device to the laser drive device.

27. A recording and reproduction control device for outputting a recording control signal to a laser drive device for driving a laser light source device to record information to an optical disk, and receiving an electrical signal from a detection device for detecting as the electrical signal a reflected light of the laser beam directed at the optical disk to reproduce information, comprising:
a recording data generation component operable to generate recording data including information to be recorded to the optical disk;
a control data generation component operable to generate control data that controls the laser drive device;
an output component operable to output to the laser drive device the recording control signal in which the recording data and the control data are multiplexed;
a control component operable to control at least one of the recording data generation component, the control data generation component, and the output component; and
a reproduction signal processing component operable to receive the electrical signal from the detection device and reproducing information.

28. The recording and reproduction control device according to claim 27,
wherein the output component transmits the recording control signal as a low amplitude differential signal.
